(19) United States
(12) Patent Application Publication
(10) Pub. No.: US 2007/0022367 A1
(43) Pub. Date: Jan. 25, 2007

(54) Multidimensional tabbing for electronic devices

(75) Inventors: Michael Ingrassia, Dallas, TX (US); Tolga Capin, Fort Worth, TX (US); Suresh Chitturi, Irving, TX (US); Antonio Haro, Dallas, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/174,093

(22) Filed: Jun. 30, 2005

(51) Int. Cl. G06F 17/00; G06F 15/00

(52) U.S. Cl. 715/501.1

(57) ABSTRACT

The invention relates to a method for displaying and manipulating a data object on a display of a mobile electronic device utilizing multi-dimensional tabbing. The invention relates also to a means for creating the data object. The method utilizes information arranged in a tree like hierarchy in the memory of the electronic device. The user of the cellular terminal can move back and forth from one level in the tree hierarchy to other level or inside one level by tabbing.

### FIELD OF THE INVENTION

The invention relates to a method for manipulating information on a display of an electronic device. The method utilizes a tree like hierarchy of information. The user of the electronic device can move from one level in the tree hierarchy to other level or inside one level by multidimensional tabbing.

### BACKGROUND OF THE INVENTION

In a typical PC environment, the user has adequate input and output devices at their disposal. For example, their monitor is of a reasonably high resolution and they have access both to a pointing device (e.g. mouse) and a keyboard. When an application requires the user to examine or enter large amounts of graphical or text based data, they can do so using any of the above means.

To expedite data entry the concepts of keyboard focus and tab traversal have become standard. The logic behind these ideas is that if we allow the user to focus on using the keyboard exclusively for input on forms then this will drastically increase efficiency. The way this works is when the user is required to enter a large amount of data they are presented with a form that includes many input display objects. When the form is first displayed, the keyboard focus is set to the first logical input display object. All keystrokes are sent to the display object with the current focus. Immediately the user can begin typing to fill in the appropriate data. When the user is done with the current field they can advance to the next logical input display object by pressing the “tab” key. In addition to the use of the “tab” key to move forward, it is also standard convention to allow “shift-tab” to move backwards in the logical sequence of input display objects.

When the user is presented with a large amount of data to examine and navigate, the pointing device (e.g. mouse) becomes the most useful. Consider the case of viewing a typical web page. The user can visually scan the page, find the desired link, and select it with the pointing device. Using the keyboard is also an option, but imagine having to use the tab traversal method to tab through a list of thirty links just to get to the one at the bottom of the page that you desire.

Compared to a typical PC, most mobile devices have a much smaller display and the means of input are limited. Applications that require the user to enter or examine large amounts of data are cumbersome in this environment. Examples of such applications include interactive maps, web browsing, entering data on complex forms, or viewing multi-page word processor documents.

The concepts of keyboard focus and tab traversal are currently a one-dimensional scheme. This poses a problem when the user has to select a single display object from a large group of data. With no pointing device the user has to manually traverse through every single display object that stands between the currently selected display object and the one the user wants.

The logical sequencing that is used in tab traversal today only allows a one-dimensional list to be defined. Most application programming environments provide an attribute for each display object that specifies an integer value to define the exact position this display object should take within the linear tabbing order. For example, the HTML specification defines the tab index attribute for use in forms. [17.11.1, HTML 4.01 Specification, December 1999, W3C, http://www.w3.org/TR/REC-html40/]

In case of one-dimensional tabbing, user must traverse list of display objects one single item at a time. There are no provisions to allow a logically nested grouping of related display objects. For example, when trying to navigate a map on a mobile device that has forty points of interest on it. Without a pointing device the user would have to traverse through each of the forty points one by one. If there was a way to define a tab order that was multidimensional and logically grouped, this would greatly increase usability.

For data input on mobile devices the core concepts of keyboard focus and tab traversal exists but is only one-dimensional; guideline 9.4 section 6, Web Accessibility Guidelines 1.0, May 1999, W3C or http://www.w3.org/TR/WAI-WEBCONTENT.

For the examination and navigation of large data sets there are various display objects, such as the tree view that group related items in a nested multi-dimensional organization. However, this method is not appropriate for applications like mapping where spatial information needs to be visually communicated to the user.

### SUMMARY OF THE INVENTION

An object of the invention is to provide a new and cost effective multidimensional tabbing scheme for the user interface of mobile devices.

Another object of the invention is to provide a new method for displaying display objects of multidimensional data structures.

Another object of the invention is to provide a new method for generating multidimensional data structures.

Another object of the invention is to provide content generator utilized when multi-dimensional data structures are created.

Another object of the invention is to provide a data object utilized in multidimensional data structures.

Another object of the invention is to provide a mobile electronic device capable of utilizing multidimensional tabbing process.

Yet another object of the invention is to provide a computer program product for making possible multidimensional tabbing in an electronic device.

The objects of the invention are achieved by a method where the content creator, or application developer, can define logical groupings of related data in a nested and ordered fashion by utilizing a cat-index according to the invention. This logical grouping by cat-indexes can be parsed in an electronic device and after that visually displayed and navigated by the user in a variety of manners on a display of a mobile electronic device.

An advantage of the invention is that a user of a mobile device has the ability to quickly navigate large sets of data without having to sift through irrelevant information display object by display object in a way applications earlier were typically restricted to the PC due to usability issues.

Another advantage of the invention is that when used with a maping application in a mobile device the user does not have to step through each map display object one at a time in a random order while viewing.

Another advantage of the invention is that data entries on complex form are made easier and faster, for example, when purchasing goods from an online retailer because the user can tab directly to those goods or groups of goods which he or she is interested in.

A further advantage of the invention is that when Web browsing on a mobile terminal, for example a well-known news site, the invention can help the user quickly navigate to a story or to a group of stories where the story that interests the user lies without wasting time on stories which are not interesting.

A further advantage of the invention is that when viewing multi-page documents, when the document (e.g. slide set) supports multidimensional tabbing, the user can quickly navigate the pages (e.g. slides) and activate a content deep within them.

A further advantage of the invention is that when utilized with phonebook navigation multi-dimensional tabbing allows users to customize their phonebooks as much as they want while not punishing them for creating complex relationships among entries or for having large numbers of entries in their phone books.

Yet another advantage of the invention is that when used with gaming, for example when playing a military simulation game, the player can easily give different orders and sub-orders to several dozen units or groups of units by utilizing the method according to the invention.

Further scope of applicability of the present invention will become apparent from the detailed description given hereafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention and wherein

FIG. 1a shows an example of cat-index attributes according to the invention;

FIG. 1b shows an overview of a display of a mobile device where the method according to the invention is used to group the display objects of certain kind in the first level on a map;

FIG. 1c shows an overview of a display of a mobile device when a tabbing on the first level has been performed and which has brought about a change in the grouping;

FIG. 1d shows an overview of a display of a mobile device when a tabbing on the second level has been performed and which has brought about a change in the shown information;

FIG. 2 shows an embodiment where on a display of a mobile device the tabbing according to the invention is utilized in viewing multi page documents with numerous links;

FIG. 3 shows as an exemplary flow chart including main stages of the method according to the invention when utilized in a mobile device; and

FIG. 4 shows as an exemplary block diagram the main functional parts of a cellular terminal where the method according to the invention is utilized.

### DETAILED DESCRIPTION

Method for defining a multidimensional tabbing layout in content according to the invention is following. There are two primary pieces of information to consider when defining a multidimensional tabbing layout according to the invention that is utilized in a mobile device, for example in a cellular terminal, which is used only as an advantageous example of electronic devices where the invention can be implemented.

First, there is provided a means to define the logical and hierarchical grouping that is allowed in multidimensional tabbing. Next, there is provided a means to specify the desired tabbing order within each group of each dimension.

To achieve this, advantageously a two number cat-index attribute is defined in a given content definition language specification such as HTML (HyperText Markup Language) or XML (eXtended Markup Language). The cat-index attribute is advantageously defined as a list of ordered number pairs. Each pair in the list defines the logical placement of the display object in that particular dimension. When looking at each pair, the first number defines the logical grouping that the display object belongs to, i.e. the dimension. The second number in the pair defines the logical position that the display object takes in that particular grouping or dimension.

An example of the cat-index used within a content definition language document is: cat-index=“4-2:2-1:3-3:4-1”. The above example defines a display object set that is four dimensions deep in the tabbing order.

The first dimension “4-2” specifies that it belongs to group 4 and is second in the tabbing order for the group at that dimension. The second dimension “2-1” specifies that it belongs to group 2 and is first in the tabbing order for the group at that dimension. The third dimension “3-3” specifies that it belongs to group 3 and is third in the tabbing order for the group at that dimension. The fourth dimension “4-1” specifies that it belongs to group 4 and is the first in the tabbing order for the group at that dimension.

At a bare minimum for multidimensional tabbing to work, the logical grouping for each dimension is required. The tabbing order within each grouping is not strictly required, since that can be calculated by the application or by the user interface handler depending on the case. For example, if used in a mapping application then the tabbing order can be assumed to be determined by the actual linear distance between each display object. This allows user controlled movement in a two-dimensional plane. In other use cases the tabbing order can be determined by the order in which each display object is defined in the content.

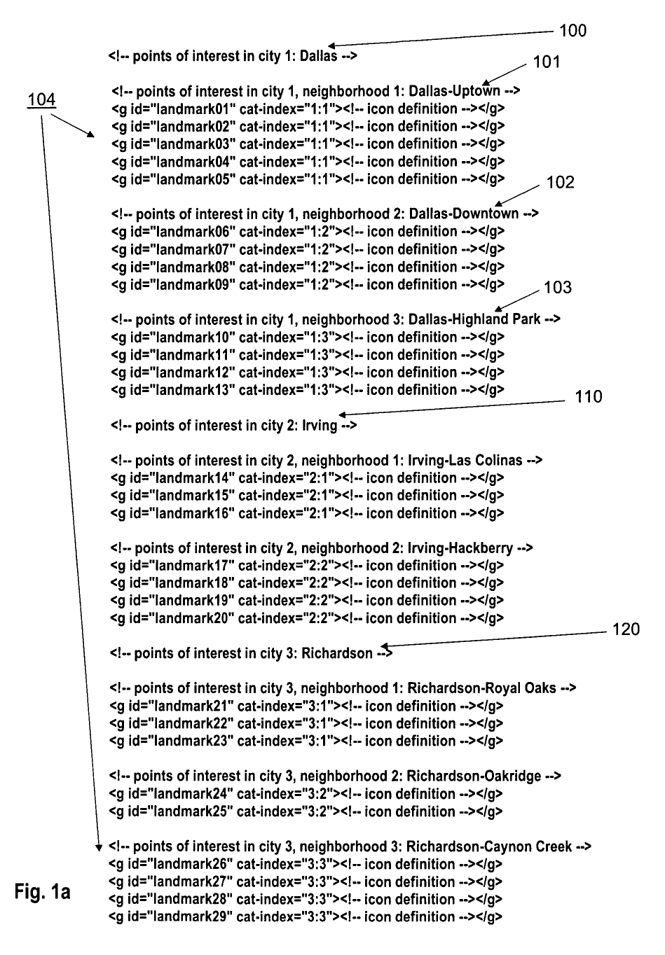

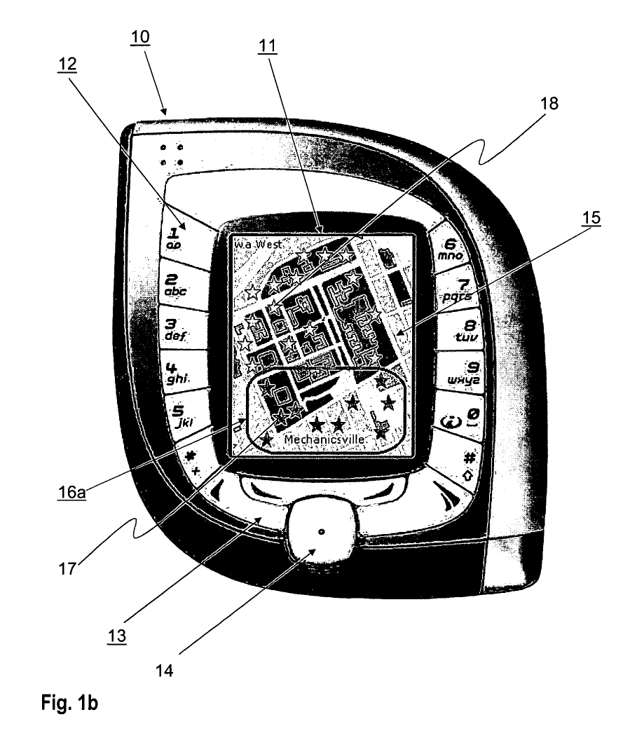

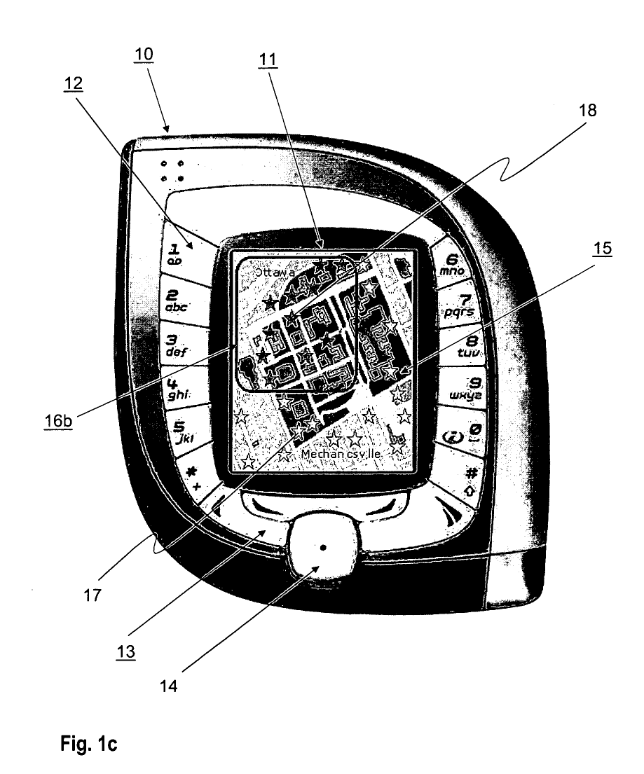

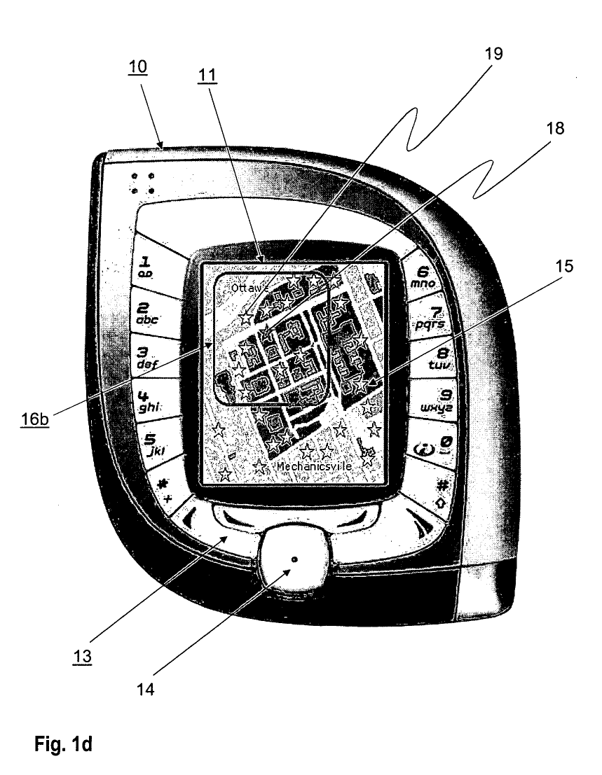

One example of the cat-index according to the invention is depicted in FIG. 1a. The example comprises twenty nine landmarks (display objects) in three cities: Dallas 100, Irving 110 and Richardson 120. Each of the mentioned cities has been divided in several dimensions (neighbourhoods). Dallas 10 has three dimensions, references 101, 102 and 103, Irving 110 has two dimensions and Richardson 120 has three dimensions. The first number in the cat-index defines the city and the second number a dimension in that particular city. In the example of FIG. 1a the first dimension comprises the three cities, second dimension the neighbourhoods and the third dimension certain landmarks in that particular neighbourhood. Altogether there are twenty nine landmarks 104 in eight neighbourhoods.

In another advantageous embodiment of the invention a cat-index attribute only specifies the logical grouping at each dimension for a particular display object. An example of this embodiment is: cat-index=“4:2:3:4”.

Expected behaviour of a user application or by the user interface handler for multi-dimensional tabbing is that the user application is always expected to start at the top level of navigation with focus going to the first top-level group. To indicate which group is currently selected the user application needs to highlight the display object or group of them in some visual way. This can be advantageously done by drawing an outline around the display objects, rendering them in a different colour, or both. From each level the user is allowed to traverse the different groups and select a group to drill down or a display object to select.

When the user selects a group to drill down into (or move up from) there are multiple alternatives that are acceptable:

The display stays at the same zoom factor, and the user can now navigate within the group;

The display zooms to have the selected group fill the display, and the user can now navigate within the group;

The display stays at the same zoom factor but pans so that the entire selected group is visible (if possible), the user can now navigate within the group (panning the display if necessary).

When the user is navigating within a group, the user application is left to make the choice to wrap the selection or bound the movement. The appropriate behaviour is dependent on the application at hand. The most appropriate data structure for internally storing the grouping and traversal information is advantageously a tree.

Some advantageous embodiments of the invention are depicted next.

A mapping application (FIGS. 1b, 1c and 1d):

FIG. 1b presents an example how a mapping application using multidimensional tabbing according to the invention would look like in a cellular terminal 10. The cellular terminal 10 advantageously comprises alpha-numeric keys 12 (numbers 1-9), function keys 13, a four-way key 14 and a display 11. The function keys 13 and/or the four-way key 14 can advantageously be utilized in the tabbing according to the invention.

In FIG. 1b on the display 11 is shown part of a city map 15, which view presents the highest dimension of tabbing. In the example, stars on the map 15 illustrate restaurants in the area, i.e. the display objects. In the example, the first level of grouping is made by neighbourhood. The currently selected neighbourhood 16a, Mechanicsville, is outlined and all of the contained restaurants of interest can be in reality for example red 17, while all that lie outside can be yellow 18 (in FIG. 1b red and yellow stars are distinguished by two shades of grey). From this point the user can use advantageously the four-way key 14 to move from one neighbourhood 16a to another neighbourhood 16b (shown in FIG. 1c) by tabbing.

FIG. 1c presents the same map application as FIG. 1b after the user has moved to a different neighbourhood 16b, Ottawa. The tabbing has been actuated for example by utilizing the four-way key 14. After the tabbing Ottawa 16b is outlined by a contour and the stars representing restaurants in Ottawa has changed their colour from yellow to red. Respectively the stars in Mechanicsville have changed from red to yellow. However, the user is further in the same (highest) dimension of tabbing.

FIG. 1d presents the same application from FIGS. 1b and 1c after the user selected next dimension of the tabbing, the Ottawa neighbourhood 16b. The selection of the next dimension can be fulfilled for example by one of the functional keys 13. After selecting Ottawa, the user is now in the second dimension of the multi-dimensional tabbing. From this point the user can move through the stars of interest within selected neighbourhood 16b by tabbing, for example, the four-way key 14. In this dimension the current star of interest is red, reference 18, while other stars of interest in the same neighbourhood 16b are light yellow, reference 19. Also the other stars outside selected neighbourhood 16b are yellow.

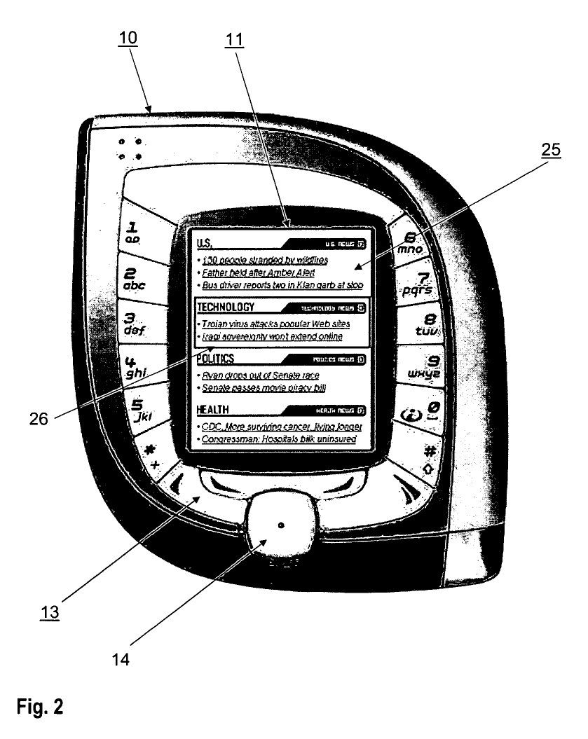

Web Browsing (FIG. 2):

FIG. 2 presents an example how browsing a typical news web site 25 would look like on a display 11 of a cellular terminal 10, which supports the multidimensional tabbing according to the invention. In FIG. 2 the user can traverse through several news items 26, for example, utilizing the four-way key 14 of the cellular terminal 10. In the example of FIG. 2 the user selects next dimension of one news group 26, Technology, by pressing for example one function key 13 when the Technology news group 26 is high lighted. After that a new selection of Technology news from the lower dimension appears on the display 11. Now the user can traverse through these Technology news in the way depicted above. By utilizing the multi-dimensional tabbing method according to the invention several times, the user can go deeper and deeper in Technology news.

Data Entry on Complex Forms:

The user of the cellular terminal is filling out a complex form on the mobile device to complete a purchase from an online retailer. Using a multidimensional tabbing scheme, the user can quickly navigate through the form. At the first dimension of tabbing the user moves between groups of related input display objects (i.e. billing address, shipping address, payment information, etc). Once the user selects a group, he presses a key to move down to the next dimension of tabbing. In this next dimension of tabbing, the user now moves through only the input fields from the chosen first dimension.

Viewing Multi-Page Documents:

The user is browsing a presentation slide set on the mobile device. Since the application displaying the slide set supports multidimensional tabbing, the user can quickly navigate the slides and activate content deep within them. At the first dimension the user can navigate over a collection of thumbnails of each slide. Once the user selects a particular slide, he presses a key to move down to the next dimension of tabbing. In this next dimension the user now navigates the items of just the chosen slide. The user can select a display object (i.e. a sound clip, external image, etc) and activate it.

Gaming:

A user is playing a military simulation game and has to give different orders and sub-orders to several dozen units. On a PC or console, the joystick or mouse can be used to point and click on units and scroll through the battlefield. On a mobile terminal, since the joystick is designed for scrolling, it is small and uncomfortable to use for extended periods. Also, there is no efficient way to “tab” through all units on a terminal without using multi-dimensional tabbing as described in this application. Multi-dimensional tabbing is also valuable in other types of games, especially those with intricate user interfaces with many variables to set (e.g. The Sims, Sim City, Railroad Tycoon) as well as role playing games (e.g. to assign which of several user characters should attack which one of several enemies).

Phonebook Navigation:

Currently, it is difficult for users with smaller displays to navigate through large lists of phone numbers. There is not enough room to show the user the tree and sub-trees representing each group in his personal phonebook. Even if larger displays are available, it is difficult to perform or create circular-style lookups (e.g. looking up the co-worker of a friend of a friend) without significantly larger displays and more complex user interfaces. Multi-dimensional tabbing allows both types of users to customize their phone books as much as they want while not punishing them for creating complex relationships among entries or for having large numbers of entries in their phone books.

The examples of the invention depicted above have a common feature which makes possible to utilize the invention in so many ways. Any data or display object belonging to the content of a multidimensional data hierarchy has a tag that defines unambiguously what the relation of that particular data object is to other data objects in the data hierarchy. This is accomplished by the cat-index according to the invention which is attached to every data object when that particular data object is created.

A means that adds a tag according to the invention to a data object to be displayed later on is called a data content generator. The content of the tag or proper data object can be created for example using HTML or XML languages.

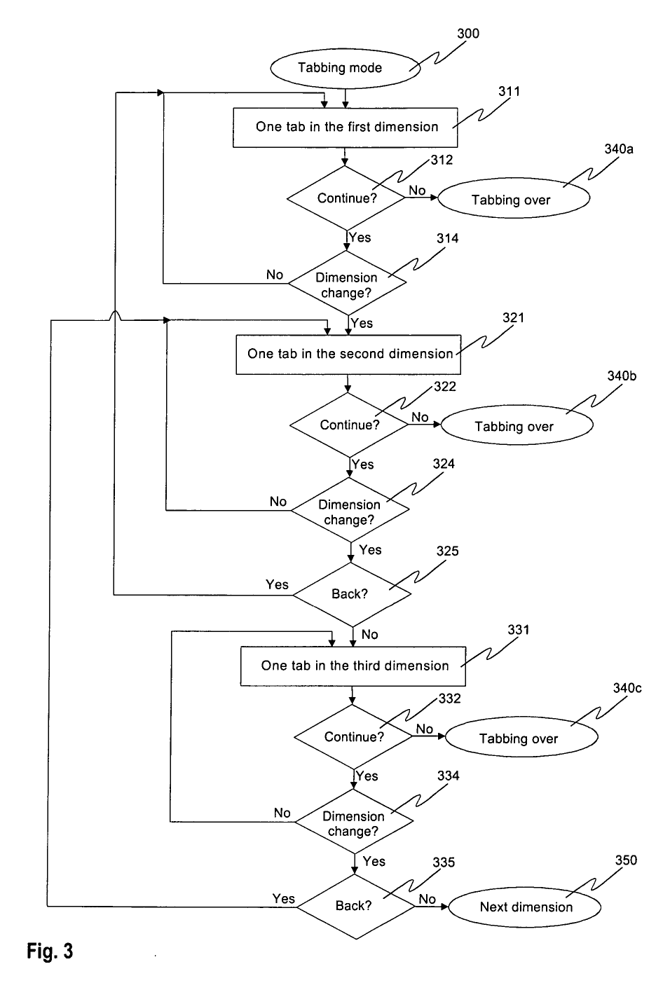

FIG. 3 shows as an exemplary flow diagram the main steps of a tabbing method according to the invention when utilized in a mobile electronic device. The device can be for example a cellular terminal.

In phase 300, if the application includes a cat-index attribute according to the invention, the cellular terminal passes automatically to the tabbing mode. This can be accomplished, for example, by parsing the cat-index included in the tag. Another alternative is that the user of the cellular terminal presses a key that sets the cellular terminal in a tabbing mode. After that, the user can traverse by tabbing through display objects of the first dimension shown on the display of the cellular terminal.

Next, in phase 311 the user gives one tab. The tab moves the cursor or like from one display object group to another in the highest dimension. In phase 312 it is checked if more tabbing is needed or not. If the comparison gives a negative answer, “No”, then the tabbing according to the invention ends in phase 340a and the cellular terminal returns to its normal functional mode, where the user can fulfil desired actions. After said actions, the user can return to phase 311 and the tabbing according to the invention can continue.

However, if the comparison 312 gives a positive answer, “Yes”, in phase 314 it is checked if a dimension change is needed from the first dimension to the second dimension or not. If the comparison 314 gives a negative answer, “No”, the user can give a further tab in phase 311. However, if the comparison 314 gives a positive answer, “Yes”, the user moves to the second dimension in the tabbing.

Next, in phase 321 the user gives one tab in the second dimension. The tab moves the cursor from one display object to another. In phase 322 it is again checked if more tabbing is needed or not. If the comparison gives a negative answer, “No”, then the tabbing according to the invention ends in phase 340b and the cellular terminal returns to its normal functional mode. However, if the comparison 322 gives a positive answer, “Yes”, in phase 324 it is checked if a dimension change is needed from the second dimension to the first or second dimension or not. If the comparison 324 gives a negative answer, “No”, the user can give a further tab in the second dimension in phase 321.

However, if the comparison 324 gives a positive answer, “Yes”, there are two possibilities. The user can move back to the first dimension, “Yes” option, or go further to the third dimension, “No” option. If the answer in comparison 325 is “Yes” the user returns to the first dimension and can give a further tab in phase 311. If the answer in the comparison 325 is “No”, the user moves to the third dimension in tabbing.

If the answer in phase 325 was “No”, in phase 331 the user gives one tab in the third dimension. The tab moves the cursor from one display object to another. In phase 332 it is again checked if more tabbing is needed or not. If the comparison gives a negative answer, “No”, then the tabbing according to the invention ends in phase 340c and the cellular terminal returns to its normal functional mode. However, if the comparison 332 gives a positive answer, “Yes”, in phase 334 it is checked if a dimension change is needed or not. If the comparison 334 gives a negative answer, “No”, the user can give a further tab in the third dimension in phase 331.

However, if the comparison 334 gives a positive answer, “Yes”, there are two possibilities. The user can move back to the second dimension, “Yes” option, or go further to the next dimension, “No” option. If the answer in comparison 335 is “Yes” the user returns to the second dimension and can give a further tab in phase 331. If the answer in the comparison 335 is “No” the user moves to the next dimension in tabbing, phase 350 (next dimension not shown in FIG. 3).

The tabbing according to the invention can end in any dimension, references 340a, 340b and 340c. In one advantageous embodiment of the invention, the user returns always to the first dimension after completing actions needed in the normal functional mode, reference 311.

In another advantageous embodiment of the invention, the user returns always to the same dimension from where the tabbing according to the invention was ended after completing actions needed in the normal functional mode, references 311, 321 and 331.

FIG. 3 shows an example of a tabbing system having three dimensions. However, the invention is not limited only to three dimensions but the tabbing system can include numerous dimensions linked together.

The tabbing according to the invention is advantageously implemented in a mobile electronic device for example in a cellular terminal by software, which comprises the method steps depicted in FIG. 3. The tabbing commands and dimension change commands can be given by keys belonging to the keyboard of the cellular terminal.

The mobile electronic device comprises also a parser according to the invention which is implemented by proper software. The parser application can find out if the data object includes a tag with cat-index according to the invention. If the tag with cat-index is found the tabbing process starts automatically. Some examples of programming languages utilized in the data objects are HTML or XML.

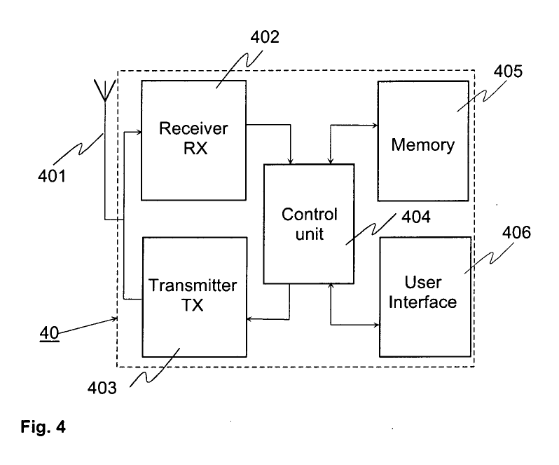

FIG. 4 shows as an exemplary block diagram of a cellular network terminal 40, where the method according to the invention can be implemented. The terminal 40 shown in FIG. 4 uses the antenna 401 in transmitting and receiving signals to and from the cellular network serving the terminal. The reference numeral 402 represents means forming a receiver RX, with which the terminal 40 receives messages from the cellular network serving it. The receiver RX comprises prior art means for all received messages or signals.

The reference numeral 403 represents means forming the transmitter TX of the cellular terminal 40. The transmitter means 403 perform all signal-processing procedures required in the operation with the cellular network serving it.

The cellular terminal 40 includes a control unit 404. It controls the operation of all main components of the cellular terminal 40. It controls also the cellular terminal's user interface UI 406, which comprises a display unit capable of showing the display objects through which the user wants to traverse. It also executes a parsing application according to the invention. It further comprises keyboard means by which the user can give commands to the cellular terminal for executing tabbing in the terminal.

The cellular terminal 40 comprises also a memory 405. The software application according to the invention for tabbing is advantageously saved in the memory 405. Also a parsing application for finding cat-indexes in the tags is advantageously saved in the memory 405. In addition, the information tied with different items or display objects are advantageously also saved in the memory 405.

Some advantageous embodiments according to the invention were described above. The invention is not limited to the embodiments described. Although the above invention was presented using a mobile terminal, it is clear for a person skilled in the art that this invention can be applied to any electronic device having means to display information to the user. For example, the invention can be implemented in various computer implementations as palmtop, laptop, desktop, tablet, media center, digiTV set-top box, home gaming/entertainment consoles, dedicated mobile communication devices utilizing wireless networking means, PDA, mobile phones, gaming consoles, media players, handtop/palmtop computers and television. The inventional idea can be applied in numerous ways within the scope defined by the claims attached hereto.

1. A method for displaying content comprising of multidimensional display object set, the method comprising the steps of:
parsing and interpreting markup language syntax which has tags defining multi-dimensional display object sets; and
displaying the content on display according to the markup language definition.

2. The method according to claim 1 wherein a tag is implemented by a catindex attribute which defines a dimension to a display object belonging to the multidimensional display object set.

3. A method for generating content having at least one multidimensional display object set the, method comprising the steps of:
choosing a specific markup language tag to define a dimension of a display object belonging to a multidimensional display object set; and
associating the tag with the display object belonging to the multidimensional display object set.

4. The method according to claim 3 wherein the tag includes a cat-index attribute which defines a dimension of the display object belonging to the multidimensional display object set.

5. A data object stored in digital form on an electronic device readable medium comprising markup language tags for defining multidimensional display object sets.

6. The data object according to claim 5 wherein a tag for defining a multidimensional display object comprises a cat-index attribute.

7. An electronic device comprising:
a control unit, memory and user interface;
a means for activating a multi-dimensional tabbing mode to traverse a multidimensional object set organized in several dimensions;
a means for showing display objects belonging to a first dimension of the multidimensional object set on the display;
a means for traversing by tabbing inside a current dimension;
a means for highlighting the current traversed display object; and
a means for bringing on the display display objects belonging to a further dimension of the multidimensional object set if a tabbing selection means is utilized.

8. The electronic device according to claim 7 wherein the electronic device further comprises a means for returning to show display objects belonging to the previous selected dimension of the multidimensional display object set if a means for back selection is utilized.

9. The electronic device according to claim 7 wherein display objects shown on the display belong to one of the following category: a map application, Web browsing, data entry on complex forms, viewing of a multi-page document, phonebook navigation or gaming application.

10. The electronic device according to claim 7 where the electronic device is a mobile phone, computer, PDA, digiTV set-top box, gaming console, media player or television.

11. A computer program product comprising:
a computer usable medium having computer readable code means embodied therein for enabling multi-dimensional tabbing in an electronic device;
computer readable code means for activating a multi-dimensional tabbing mode;
computer readable code means for displaying display objects of a multidimensional object set;
computer readable code means for showing display objects belonging to the first dimension of the multidimensional object set;
computer readable code means for traversing display objects belonging to the first dimension of the multidimensional object set on the display;
computer readable code means for highlighting a current display object; and
computer readable code means for showing display objects belonging to a further dimension of the display object highlighted on the display if the tabbing selection means are utilized.

12. The computer program product according to claim 11 where display objects of the multidimensional object set are organized in several dimensions utilizing tree-like hierarchy.

13. The computer program product according to claim 12 where a dimension of a display object belonging to any dimension of the multidimensional object set is defined by a cat-index attribute.

14. The computer program product according to claim 11 which further comprises computer readable code means for returning the display to show display objects belonging to the previous selected dimension of the multidimensional object set if a means for back selection is utilized.

15. The computer program product according to claim 11 which further comprises computer readable code means for showing display objects belonging to one of the following category on the display: a map application, Web browsing, data entry on complex forms, viewing of a multi-page document, phonebook navigation or a gaming application.

16. A computer program product for displaying content of a multidimensional display object set, the computer program comprising:
computer readable code means for parsing and interpreting markup language syntax which has at least one tag defining a dimension of a display object belonging to a multidimensional display object set; and
computer readable code means for showing the content on display according to the markup language definition.

17. The computer program product according to claim 16 further comprising computer readable code means for parsing and interpreting tags having a given cat-index attribute which defines a dimension to a display object belonging to the multidimensional display object set.

18. A computer program product for generating content, the computer program comprising computer readable code means for generating content according to a given markup language syntax, wherein the content comprises at least one multi-dimensional display object sets.

19. The computer program product according to claim 18 further comprising computer readable code means for defining a tree-like hierarchy by utilizing the cat-index attributes in markup language tags.
